(19) United States
(12) Patent Application Publication
(10) Pub. No.: US 2024/0396330 A1
(43) Pub. Date: Nov. 28, 2024

(54) PROVIDING INFORMATION PERTAINING TO USE OF APPARATUS DURING POWER OUTAGE

(71) Applicant: Panasonic Intellectual Property Corporation of America, Torrance, CA (US)

(72) Inventors: Hiroko IZUMI, Kanagawa (JP); Hiroki TAKEUCHI, Osaka (JP); Mitsuko SHUTO, Osaka (JP)

(21) Appl. No.: 18/792,978

(22) Filed: Aug. 2, 2024

Related U.S. Application Data
(63) Continuation of application No. PCT/JP2022/042616, filed on Nov. 16, 2022.

(30) Foreign Application Priority Data
Feb. 3, 2022 (JP) 2022-015773

(51) Int. Cl. H02J 3/00; G05B 19/042

(52) U.S. Cl. CPC H02J 3/001; G05B 19/042; G05B 2219/2639

(57) ABSTRACT

The present disclosure provides an information provision method for providing information on usage of devices in a facility during a power outage. The method includes, upon receiving power outage information indicating that a power outage has occurred in the facility, acquiring remaining power information of a backup power supply installed in the facility, and device information on at least one device 28, 30, 32 that is operable with the backup power supply, acquiring user information of the device 28, 30, 32, determining a usage plan for the device 28, 30, 32 operable with the backup power supply, based on the remaining power information of the backup power supply and the user information, and outputting the usage plan.

This application is a continuation of PCT/JP2022/042616 filed on Nov. 16, 2022, which claims foreign priority of Japanese Patent Application No. 2022-015773 filed on Feb. 3, 2022, the entire contents of both of which are incorporated herein by reference.

### BACKGROUND OF THE INVENTION

### 1. Field of the Invention

The present disclosure relates to a method and a system for providing information on usage of devices during a power outage.

### 2. Description of Related Art

Distributed power supplies such as storage batteries are becoming popular in preparation for disasters. JP 2015-57022 A discloses a distributed power supply device that supplies power from a storage battery to a load connected to a backup distribution board, during a power outage, thereby achieving stable power supply even during the power outage. JP 2009-148009 A disclosures a power supply system that restricts devices to which power is supplied from a distributed power supply during a power outage, according to the priority levels of the devices, thereby enabling required devices to be reliably operated.

### SUMMARY OF INVENTION

As described in Patent Literatures 1 and 2, devices that can be used with the storage battery during a power outage are often determined in advance. However, the method of uniformly restricting the usable devices or reducing the amount of power to be supplied to the devices according to the remaining power of the storage battery, cannot meet individual circumstances and demands of users.

In view of the above circumstances, the present disclosure provides a technique for providing users with useful information on usage of devices during a power outage.

The present disclosure provides an information provision method for providing information on usage of devices in a facility during a power outage, the method including,
upon receiving power outage information indicating that a power outage has occurred in the facility,
acquiring remaining power information of a backup power supply installed in the facility, and device information on at least one device that is operable with the backup power supply,
acquiring user information of the device,
determining a usage plan for the device operable with the backup power supply, based on the remaining power information of the backup power supply and the user information, and
outputting the usage plan.

According to the technique of the present disclosure, when a power outage has occurred, information on usage of devices during the power outage can be provided to the user, based on user information, taking into consideration the remaining power of the backup power supply in the facility. The information to be provided is not uniform information, but is information based on the user information and therefore is information close to the user. Therefore, even during a power outage, appropriate power management can be performed based on the provided usage plan, according to individual circumstances of each user, taking into consideration the device usage status of the user during a normal time.

### BRIEF DESCRIPTION OF THE DRAWINGS

FIG. 1 is a configuration diagram showing a facility and its surrounding environment to which the method of the present embodiment is applied.

FIG. 2 is a configuration diagram of a server.

FIG. 3A is a conceptual diagram of a user information database.

FIG. 3B is a conceptual diagram of a device information database.

FIG. 3C is a conceptual diagram of another example of the device information database.

FIG. 3D is a conceptual diagram of a usage history information database.

FIG. 4 is a flowchart of a process of providing information on usage of devices during a power outage.

FIG. 5 is a diagram showing an example of information display on a terminal of a home controller.

FIG. 6 is another diagram showing an example of information display on the terminal of the home controller.

FIG. 7A is still another diagram showing an example of information display on the terminal of the home controller.

FIG. 7B is yet another diagram showing an example of information display on the terminal of the home controller.

FIG. 7C is a further diagram showing an example of information display on the terminal of the home controller.

FIG. 7D is a still further diagram showing an example of information display on the terminal of the home controller.

FIG. 7E is a yet further diagram showing an example of information display on the terminal of the home controller.

FIG. 8 is a conceptual diagram of a priority rule to be referred to when a usage plan is determined.

FIG. 9 is a diagram showing an example of information display when a plurality of usage plans are proposed as device usage methods.

FIG. 10 is a conceptual diagram of a table used for changing, according to seasons, devices that are recommended to be preferentially used.

### DETAILED DESCRIPTION

### Findings on which the Present Disclosure is Based

As described in Patent Literatures 1 and 2, devices that can be used with the storage battery during a power outage are often determined in advance. However, since power outages do not occur frequently, the user may forget the devices that can be used during a power outage and their locations. In this case, the user gets confused as soon as a power outage occurs. In addition, since the storage battery is not always fully charged, power management for effective use of power is also important. A certain user may desire to use the storage battery over as long time as possible, assuming that it will take some time before recovery of the commercial power supply. Another user may place importance on controlling the indoor temperature for his/her own or a family member's health. That is, the method of uniformly restricting the usable devices or reducing the amount of power to be supplied to the devices according to the remaining power of the storage battery, cannot meet the individual circumstances and demands of users. However, users do not have information that is a basis for realizing appropriate power management, and there is no system that delivers such information to users during a power outage.

### Outline of One Aspect According to the Present Disclosure

A method according to one aspect of the present disclosure is an information provision method for providing information on usage of devices in a facility during a power outage, and the method includes,
upon receiving power outage information indicating that a power outage has occurred in the facility,
acquiring remaining power information of a backup power supply installed in the facility, and device information on at least one device that is operable with the backup power supply,
acquiring user information of the device,
determining a usage plan for the device operable with the backup power supply, based on the remaining power information of the backup power supply and the user information, and
outputting the usage plan.

According to the method of the present disclosure, when a power outage has occurred, the user is provided with the usage plan regarding a method for using the device with the backup power supply. The usage plan prevents the user from becoming an information poor, and from being confused. Furthermore, the information to be provided is not uniform information, but is information based on the user information and therefore is information close to the user. Therefore, based on the usage plan, appropriate power management can be performed according to individual circumstances of each user. Since the usage plan is automatically delivered to the facility upon occurrence of a power outage, the user need not take any special action.

In the above aspect, for example, the method may include further acquiring usage history information of the device, and determining the usage plan, based on the usage history information, the remaining power information, and the user information. Thus, useful information and advice based on the usage history can be included in the usage plan.

In the above aspect, for example, the user information may include user attribute information indicating a user attribute that is determined based on at least one selected from the group consisting of ages of people living or working in the facility, number of the people, sexes of the people, presence or absence of diseases, and presence or absence of pregnant women, and the usage plan is determined according to the user attribute. According to the user attribute determined based on the ages, number, sexes, etc., a more appropriate usage plan can be provided to each user.

In the above aspect, for example, the device that is recommended to be preferentially used may be determined according to the user attribute, and the usage plan may include information on the device that is recommended to be preferentially used. Thus, it is possible to provide a usage plan close to the users, taking into consideration the ages, number, health conditions, etc. of the users.

In the above aspect, for example, when the device that is recommended to be preferentially used is defined as a specific device and the device other than the specific device is defined as a general device, the usage plan may be determined such that a target level of power consumption of the specific device exceeds a target level of power consumption of the general device. Thus, it is possible to recommend the user to allocate power to an important device for the user.

In the above aspect, for example, a priority of the specific device may be determined according to each of a plurality of user attributes different from each other, and the priority may represent a priority among a plurality of specific devices. When a user has a first user attribute and a second user attribute that are the user attributes different from each other, and the priority of a first specific device that is the specific device associated with the first user attribute is higher than the priority of a second specific device that is the specific device associated with the second user attribute, the usage plan may be determined such that the target level of power consumption of the first specific device exceeds the target level of power consumption of the second specific device. Even when there are a plurality of devices that are recommended to be preferentially used, setting the priorities prevents the user from using all the devices at the same pace.

In the above aspect, for example, when the device that is recommended to be preferentially used is defined as a specific device and the device other than the specific device is defined as a general device, the usage plan may be determined such that, if power consumption of the specific device during a predetermined period in the past is lower than threshold power consumption, the target level of power consumption of the specific device becomes equal to the target level of power consumption of the general device. According to such a method, a more appropriate usage plan can be delivered to the user.

In the above aspect, when the user attribute information does not include information indicating that at least one person selected from the group consisting of the elderly, infants, people having diseases, and pregnant women is included in the user, the usage plan may be determined so as to recommend reducing the target level of power consumption by the device to a first level. When the user attribute information includes information indicating that at least one person selected from the group consisting of the elderly, infants, people having diseases, and pregnant women is included in the user, the usage plan may be determined so as to recommend reducing the target level of power consumption by the device to a second level. The first level may be a target level of power consumption lower than the second level. With the usage plan being determined according to such rules, a more appropriate device usage method can be proposed to the user who is concerned about his/her physical strength.

In the above aspect, for example, the target level of power consumption may be an index that is expressed by a ratio to power consumption for one day of the device, which is specified based on usage history of the device.

In the above aspect, for example, the facility may be a general house, and the user attribute may be a family composition that is determined based on at least one selected from the group consisting of ages, number of people, sexes, presence or absence of diseases, and presence or absence of pregnant women. According to such a method, convenience of a distributed power supply such as a storage battery can be improved, and spread of the distributed power supply can be promoted.

In the above aspect, for example, the usage plan may be determined based on the usage history information, the remaining power information, and the user information.

In the above aspect, for example, the usage plan may include time information indicating a remaining available time when the device is used with the backup power supply, and the available time may be calculated from the usage history information and the remaining power information. When the usage plan is determined based on the usage history information, the remaining power information, and the user information, useful information and advice based on the usage history can be included in the usage plan.

In the above aspect, for example, the usage plan may include information on a method for using the device such that an actual usage time is extended to be longer than the available time calculated from the usage history information and the remaining power information. Such information is particularly useful for the user who desires to use the backup power supply for as long time as possible.

In the above aspect, for example, the user attribute information may be acquired from a database in which information on the user is recorded in advance. Utilizing the database allows a proposal according to the individual circumstances of each user to be provided to the user.

In the above aspect, for example, the at least one device may include a plurality of devices, and locations, in the facility, of the plurality of devices that are operable with the backup power supply may be displayed and outputted with characters, graphics, symbols, colors, or a combination thereof. According to such a display mode, even when there are many operable devices, the user can grasp the operable devices and the locations thereof at a glance.

In the above aspect, for example, the user information may be recorded in advance on a database of a server on the web, and may be acquired from the database, the remaining power information may be transmitted to the server via an energy management system installed in the facility together with the backup power supply, and the usage plan may be determined in the server. According to such a method, there is no need to impose an excessive equipment burden on the user's facility.

A system according to one aspect of the present disclosure is an information provision system that provides information on usage of devices in a facility during a power outage, and the system includes:
a remaining power information acquisition unit that acquires remaining power information of a backup power supply installed in the facility, upon acquiring power outage information indicating that a power outage has occurred in the facility;
a device information acquisition unit that acquires, during the power outage, device information on at least one device that is operable with the backup power supply;
a user information acquisition unit that acquires user information of the device;
a plan determination unit that determines a usage plan for the device operable with the backup power supply, based on the remaining power information of the backup power supply and the user information; and
an output unit that outputs the usage plan.

A computer program according to one aspect of the present disclosure is a computer program for providing information on usage of devices in a facility during a power outage, and the computer program causes a computer to execute,
upon receiving power outage information indicating that a power outage has occurred in the facility,
a process of acquiring remaining power information of a backup power supply installed in the facility, and device information on at least one device that is operable with the backup power supply,
a process of acquiring user information of the device,
a process of determining a usage plan for the device operable with the backup power supply, based on the remaining power information of the backup power supply and the user information, and
a process of outputting the usage plan.

Another aspect of the present disclosure provides a recording medium in which the computer program is recorded. The recording medium may be an optical recording medium such as a CD (Compact Disk), a semiconductor recording medium such as a flash memory, or a DVD (Digital Versatile Disc), or a magnetic recording medium such as a magnetic tape. The type of the recording medium is not particularly limited.

Hereinafter, an embodiment of the present disclosure will be described with reference to the drawings. The present disclosure is not limited to the embodiment described below.

### Embodiment

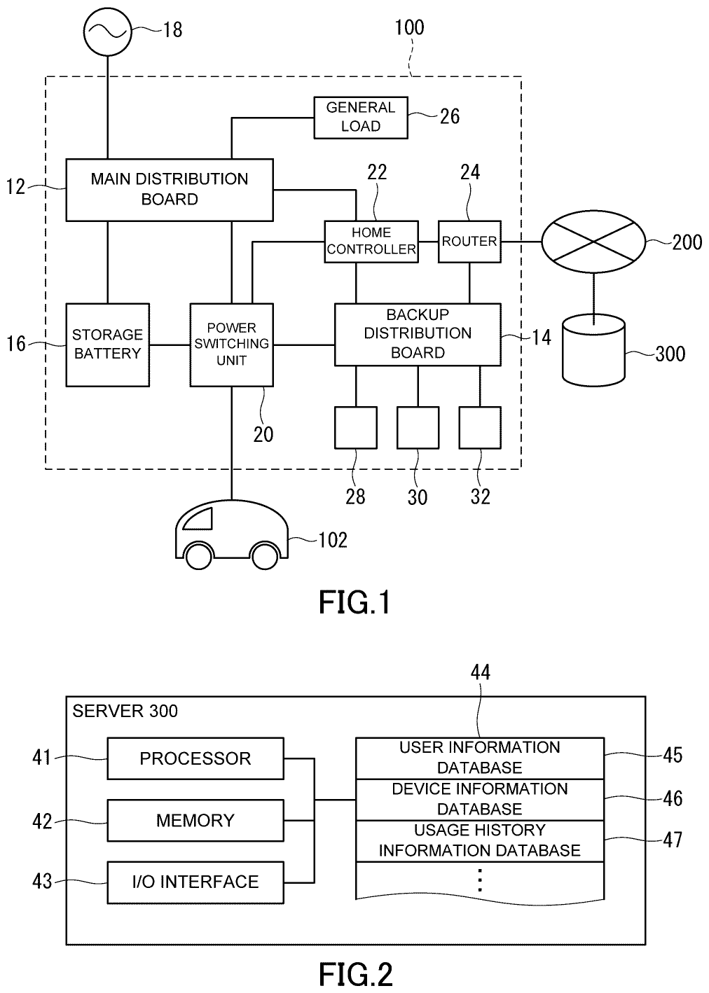

FIG. 1 is a configuration diagram showing a facility and its surrounding environment to which the method of the present embodiment is applied In the facility, electrical equipment 100 includes a main distribution board 12, a backup distribution board 14, a storage battery 16, and a power switching unit 20. The main distribution board 12 is connected to a commercial power supply 18. Power from the commercial power supply 18 is supplied to the main distribution board 12. The backup distribution board 14, the storage battery 16, and a general load 26 are connected to the main distribution board 12. Power is supplied from the main distribution board 12 to the backup distribution board 14, the storage battery 16, and the general load 26. The general load 26 is a device that cannot be used during a power outage.

The facility shown in FIG. 1 is typically a general house. Other examples of the facility include a hospital, an office building, a public facility, temporary housing installed outdoors, and the like.

The storage battery 16 is an example of a backup power supply that is operated during a power outage. Other examples of the backup power supply include a diesel generator, a fuel cell, and the like. In the example shown in FIG. 1, an electric vehicle 102 is connected to the backup distribution board 14 through the power switching unit 20. That is, the electric vehicle 102 may be used as a backup power supply.

The backup distribution board 14 is connected to the main distribution board 12 through the power switching unit 20. A home controller 22, a router 24, a device 28, a device 30, and a device 32 are connected to the backup distribution board 14. The home controller 22, the router 24, the device 28, the device 30, and the device 32 are devices to which power is supplied from the storage battery 16 through the backup distribution board 14 during a power outage. The devices 28, 30, and 32 are electrical devices. The devices 28, 30, and 32 that can be used during a power outage are determined in advance. For example, the device 28 is an air conditioner in a living room, the device 30 is lighting in the living room, and the device 32 is a refrigerator. In this embodiment, a plurality of devices 28, 30, and 32 can be used during a power outage. The number of devices that can be used during a power outage is not particularly limited. It is at least one, and is typically two or more. In some cases, all the devices (electrical devices) in the facility may be usable during a power outage.

The home controller 22 is connected to the main distribution board 12, the backup distribution board 14, and the power switching unit 20, and monitors and records daily and/or hourly power consumption (kWh) of the device 28, the device 30, and the device 32. That is, the home controller 22 may have the function of HEMS (Home Energy Management System). The home controller 22 is a user-side system, and is connected to a communication network 200 such as the Internet through the router 24. Data of power consumption collected by the home controller 22 is sent to a server 300 on the communication network 200. The server 300 creates a database regarding usage histories of the device 28, the device 30, and the device 32. The database regarding the usage histories is, for example, a database in which daily power consumption of each of the device 28, the device 30, and the device 32 is recorded. The home controller 22 and the server 300 have a client-server relationship.

The home controller 22 may be a system having various extended functions, in addition to monitoring and recording of power consumption. In one example, the home controller 22 may have the function of “HomeX (registered trademark)” system provided by Panasonic Corporation.

When a power outage has occurred in the facility, the server 300 creates information on usage of the devices 28, 30, and 32 in the facility, and provides the information to a user who is a resident or a visitor of the facility. The information on usage of the devices 28, 30, and 32 may be created in response to a request from the home controller 22. The server 300 may be a cloud server or an edge server.

The power switching unit 20 relays between the backup distribution board 14 and the storage battery 16. The power switching unit 20 monitors the voltage of the commercial power supply 18 supplied to the main distribution board 12 to detect presence/absence of a power outage. When a power outage has occurred, the power of the storage battery 16 is supplied to the devices connected to the backup distribution board 14 through the backup distribution board 14. Specifically, the power switching unit 20 operates to disconnect the backup distribution board 14 from the main distribution board 12, and connect the backup distribution board 14 to the storage battery 16, whereby the power of the storage battery 16 is supplied to the backup distribution board 14.

The home controller 22 monitors the voltage of the commercial power supply 18 supplied to the main distribution board 12 to determine whether a power outage has occurred. When a power outage has occurred in the facility, the home controller 22 notifies the server 300 of the occurrence of the power outage in the facility, through the router 24 and the communication network 200. Upon receiving the notification about the occurrence of the power outage in the facility, the server 300 creates information on usage of the devices 28, 30, and 32, and transmits the information toward the home controller 22. The information on usage of the devices 28, 30, and 32 is outputted to terminals such as the terminal of the home controller 22 and a mobile communication terminal of the user. Examples of the mobile communication terminal of the user include a smart phone, a tablet computer, and the like. The output format is display output, voice output, or a combination thereof. Typically, it is display output.

The “information on usage of the devices 28, 30, and 32” includes a usage plan for the devices 28, 30, and 32 that can be operated with the storage battery 16. For example, when the device 28 is an air conditioner, the usage plan includes the set temperature of the air conditioner, the usage time per day of the air conditioner, and the like. The usage plan may also include information on a device, the use of which is recommended to be avoided or reduced.

FIG. 2 is a configuration diagram of the server 300. The server 300 is a computer unit that executes processes in flowcharts described below. The server 300 includes a processor 41, a memory 42, an I/O interface 43, a storage 44, and the like. The storage 44 has, stored therein, a user information database 45, a device information database 46, and a usage history information database 47. In addition, the storage 44 has, stored therein, a program for creating the information on usage of the devices 28, 30, and 32 during a power outage. The program is read into the memory 42 being a work area, and is executed by the processor 41. The information is transmitted and received through the I/O interface 43.

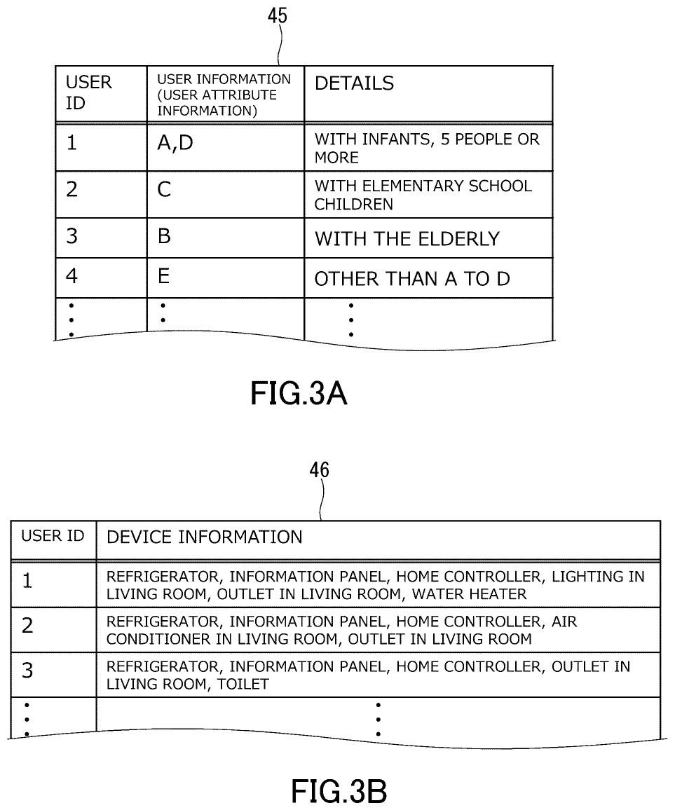

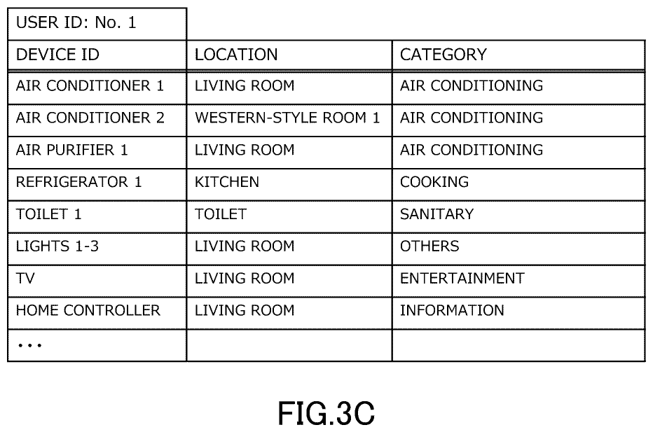

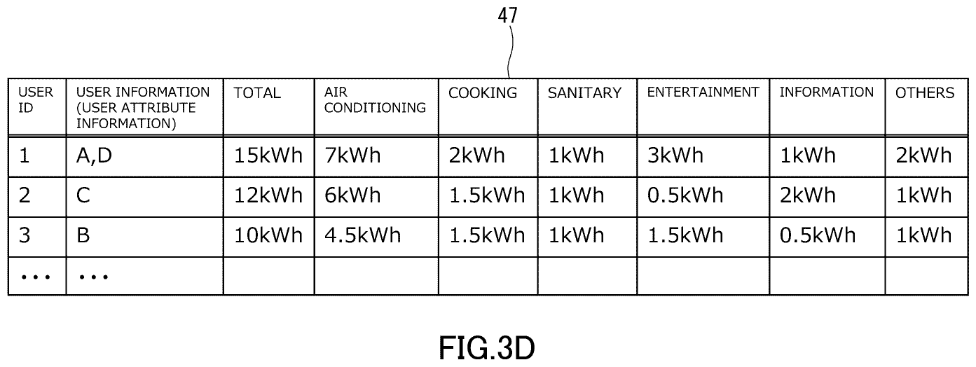

FIG. 3A is a conceptual diagram of the user information database 45. In the user information database 45, user information is recorded in association with user ID. The user information is information on the user who receives an information delivery service during a power outage, and is information on the user who uses the devices 28, 30, and 32 in the facility where the storage battery 16 is installed. Specifically, the user information includes user attribute information indicating a user attribute that is determined based on at least one selected from the group consisting of the ages of people living or working in the facility, the number of the people, the sexes of the people, presence/absence of disease, and presence/absence of pregnant woman. Utilizing the user information database allows a proposal according to the individual circumstances of each user to be provided to the user.

In the example shown in FIG. 3A, a user having a user ID of No. 1 has an attribute specified by user attributes A and D. A user having a user ID of No. 2 has an attribute specified by a user attribute C. A user having a user ID of No. 3 has an attribute specified by a user attribute B. A user having a user ID of No. 4 has an attribute specified by a user attribute E. The user attribute A is a user attribute when infants (ranging from 0 years old to preschool children) are included in the people living in the facility. The user attribute B is a user attribute when the elderly (aged 65 and over) is included in the people living in the facility. The user attribute C is a user attribute when elementary school children are included in the people living in the facility. The user attribute D is a user attribute when the number of the people living in the facility is five or more. The user attribute E is a user attribute when none of the user attributes A to D applies. For example, a family of a married couple in their thirties corresponds to the user attribute E. The attributes of “infants”, “the elderly”, and “elementary school children” are user attributes that are determined based on the ages of the people living in the facility. The attribute of “five or more” is a user attribute that is determined based on the number of the people living in the facility. In addition to the above user attributes, there are user attributes that are determined based on presence/absence of diseases, presence/absence of pregnant women, and the like.

In the present embodiment, the people living or working in the facility are family members. That is, the facility is a general house, and the user attribute is a family composition that is determined based on at least one selected from the group consisting of the ages, the number of people, the sexes, presence/absence of diseases, and presence/absence of pregnant women. The method of the present embodiment is particularly suitable for general houses and families living there. According to the method of the present embodiment, convenience of a distributed power supply such as the storage battery 16 can be improved, and spread of the distributed power supply can be promoted.

The user information database 45 is created and updated at a predetermined timing such as when a new facility is built, when the age of a person living in the facility has changed, or when the number of the people living in the facility is increased. The user information database 45 may be created and updated by the user himself/herself from the terminal of the home controller 22, or by an administrator of the server 300.

FIG. 3B is a conceptual diagram of the device information database 46. In the device information database 46, device information, which is information on devices that can be operated with the storage battery 16 during a power outage, is recorded in association with user ID. In the facility of the user having the user ID of No. 1, a refrigerator, an information panel (TV), a home controller, lighting in the living room, an outlet in the living room, and a water heater are set as devices that can be operated with the storage battery 16. In the facility of the user having the user ID of No. 2, a refrigerator, an information panel (TV), a home controller, an air conditioner in the living room, and an outlet in the living room are set as devices that can be operated with the storage battery 16 during a power outage. In the facility of the user having the user ID of No. 3, a refrigerator, an information panel (TV), a home controller, an outlet in the living room, and a toilet are set as devices that can be operated with the storage battery 16 during a power outage.

FIG. 3C is a conceptual diagram of another example of the information device database 46. In the example shown in FIG. 3C, a device ID is assigned to each of the devices that can be operated with the storage battery 16. In association with the device IDs, locations where the devices are placed are recorded. The locations where the devices are placed can be used when the locations of the devices are displayed on the drawing of the facility as described later. In association with the device IDs, device categories are recorded. The device category is determined and recorded according to application of the device associated with each device ID. Based on the usage statuses of the devices, devices that are frequently used at the same time or devices that are used at close timings may be collectively recorded in the device category. For example, an air conditioner 1, an air conditioner 2, and an air purifier 1 are separated devices, but belong to the same category “air conditioning”. The “air conditioning” is the category of devices having any one of functions of adjusting the indoor temperature, adjusting the indoor humidity, and purifying the indoor air. A refrigerator 1 belongs to the category of “cooking”. The “cooking” is the category of devices placed in the kitchen. A toilet 1 belongs to the category of “sanitary”. Lights 1 to 3 belong to the category of “others”. A TV belongs to the category of “entertainment”. A home controller belongs to the category of “information”. The “information” is the category of devices having either the function for acquiring information through the network or the function of performing communication through the network. As described above, the device categories are recorded in association with the device IDs, and are displayed together with the locations of the devices when determining and outputting a usage plan. This allows the user to select a usage plan, based on the user's daily application of the devices even during an abnormal situation (power outage).

The device information database 46 is updated when, for example, a new facility is built or when there is a change in the devices that can be operated with the storage battery 16 during a power outage. The device information database 46 may be updated by the user himself/herself from the terminal of the home controller 22, or by the administrator of the server 300.

FIG. 3D is a conceptual diagram of the usage history information database 47. In the usage history information database 47, usage history information, which is information on the usage histories of the devices that can be operated with the storage battery 16 during a power outage, is recorded in association with user IDs. The usage history information includes information indicating the device categories, and power consumption of the devices that belong to the categories. The power consumption may be an average value for the last one week, or an average value for the last one month.

In the example shown in FIG. 3D, the usage history information is recorded for each of the device categories such as “air conditioning”, “cooking”, “sanitary”, “entertainment”, “information”, and “others”. However, in the usage history information database 47, individual usage histories of the devices 28, 30, and 32 that can be operated with the storage battery 16 during a power outage may be recorded together with the power consumptions thereof. That is, the usage histories of the devices recorded in the device information database 46 shown in FIG. 3B, such as “refrigerator”, “information panel”, “lighting in the living room”, may be recorded in the usage history information database 47. However, the devices that can be operated with the storage battery 16 during a power outage may be changed, and the home controller 22 may be able to collect the power consumptions of all the electrical devices in the facility such as a general house. Therefore, the power consumptions of all the devices in the facility may be recorded for each device in the usage history information database 47. Only the usage histories of the devices 28, 30, and 32 that can be operated with the storage battery 16 can be read out according to need.

The usage history information database 47 is periodically updated based on the information collected by the home controller 22. The periodical update may be performed once every day, or once every other week. In the usage history information database 47, the power consumption of each device for the past one year (365 days) may be recorded.

As shown in FIG. 3D, the user attribute information may be recorded together with the usage history information in the usage history information database 47.

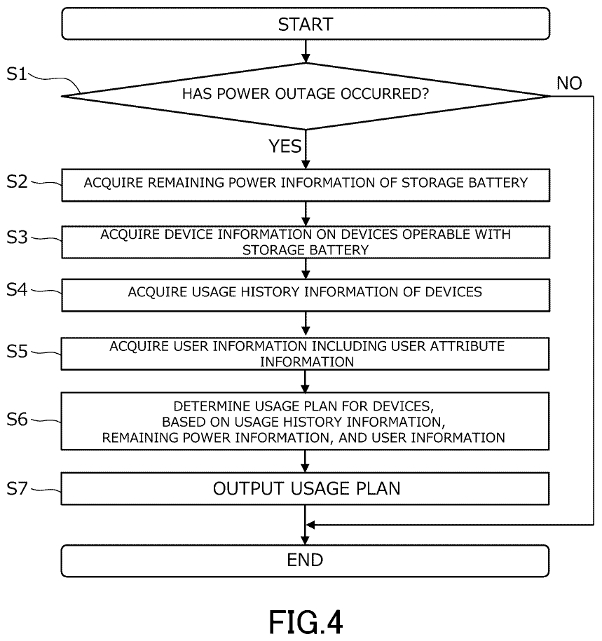

FIG. 4 is a flowchart showing processes of providing information on usage of the devices 28, 30, and 32 during a power outage. Upon receiving a notification indicating that a power outage has occurred in the facility, the server 300 executes the processes described in the flowchart. That is, the server 300 is an example of a system that provides the information on usage of the devices 28, 30, and 32 during a power outage.

However, the server 300 is not essential. The home controller 22 installed in the facility may execute all the processes described in the flowchart. The home controller 22 may have the databases described with reference to FIGS. 3A to 3D. That is, the home controller 22 may also serve as the system that provides the information on usage of the devices 28, 30, and 32 during a power outage. In this case, the system is a standalone system in which the facility does not communicate with the outside. Furthermore, the server 300 and the home controller 22 may share the processes described in the flowchart.

In step S1 in FIG. 4, the server 300 determines whether a power outage has occurred in the facility. Upon acquiring power outage information, the server 300 determines that a power outage has occurred in the facility. That is, the server 300 monitors presence/absence of a power outage in the facility. Upon receiving the power outage information, the server 300 executes processes in step S2 and subsequent steps. The power outage information is information indicating that a power outage has occurred in the facility. The power outage information also includes the user ID for specifying the facility. This allows the server 300 to specify the facility in which the power outage has occurred. The power outage information is typically transmitted from the facility to the server 300. The power outage information may be information provided from an electric power company.

In step S2, the server 300 acquires remaining power information of the storage battery 16. Upon receiving the power outage information, the server 300 acquires the remaining power information of the storage battery 16. The remaining power information of the storage battery 16 is information indicating the present amount of power (kWh) stored in the storage battery 16. The present amount of power is an amount of power stored in the storage battery 16 at the time when the power outage has occurred. The amount of power stored in the storage battery 16 is always managed by the home controller 22, and is transmitted from the home controller 22 to the server 300 in response to a request from the server 300. Alternatively, the remaining power information may be transmitted from the home controller 22 to the server 300 together with the power outage information when the power outage information is transmitted to the server 300.

Next, in step S3, the server 300 acquires device information on the devices 28, 30, and 32 that can be operated with the storage battery 16. The device information is recorded in the device information database 46 described with reference to FIG. 3B. Therefore, in step S3, the device information corresponding to the user ID is read out from the device information database 46.

Next, in step S4, the server 300 acquires usage history information on the usage histories of the devices 28, 30, and 32 that can be operated with the storage battery 16. The usage history information is recorded in the usage history information database 47 described with reference to FIG. 3D. Therefore, in step S4, the usage history information corresponding to the user ID and related to the devices that can be operated with the storage battery 16, is read out from the usage history information database 47.

Next, in step S5, the server 300 acquires user information including user attribute information. The user information is recorded in the user information database 45 described with reference to FIG. 3A. Therefore, in step S5, the user information corresponding to the user ID is read out from the user information database 45.

The order of the processes from step S2 to step S5 is not limited to the example shown in FIG. 4. The order in which these processes are executed is not particularly limited.

Next, in step S6, a usage plan for the devices 28, 30, and 32 is determined based on the usage history information, the remaining power information, and the user information. The usage plan includes a proposal regarding how to use the devices 28, 30, and 32 with the storage battery 16. In step S6, the present amount of stored power is converted to the available time of the devices 28, 30, and 32.

In the present embodiment, the user information is recorded in advance in the database of the server 300 on the web, and the user information is acquired from the database. The remaining power information is transmitted to the server 300 via an energy management system installed in the facility together with the storage battery 16, and the server 300 determines a usage plan. The home controller 22 plays the role of the energy management system. According to such a method, there is no need to impose an excessive equipment burden on the user' facility.

In step S6, the usage plan may be determined based only on the remaining power information and the user information, without using the usage history information. However, if the usage plan is determined based on the usage history information, the remaining power information, and the user information, useful information and advice based on the usage history can be included in the usage plan.

As described with reference to FIG. 3A, the user information includes the user attribute information indicating the user attribute. Therefore, in step S6, the usage plan is determined according to the user attribute. According to the user attribute that is determined based on ages, number of people, sexes, etc., it is possible to provide the user with more appropriate usage plan.

Finally, in step S7, the determined usage plan is outputted. Specifically, the server 300 transmits the determined usage plan to the home controller 22 of the facility in which the power outage has occurred. Upon receiving the usage plan, the home controller 22 displays the usage plan on a terminal device such as the terminal of the home controller 22 or the user's mobile communication terminal.

According to the present embodiment, when a power outage has occurred, the usage plan for using the devices 28, 30, and 32 with the storage battery 16 is provided to the user in real time. This prevents the user from becoming information poor, and from being confused during the power outage. Furthermore, the provided information is not uniform information, but is based on the user information and therefore is information close to the user. Therefore, it is possible to realize appropriate power management according to user's individual circumstance, based on the usage plan. Since the usage plan is automatically delivered to the facility upon occurrence of a power outage, the user need not take any special action.

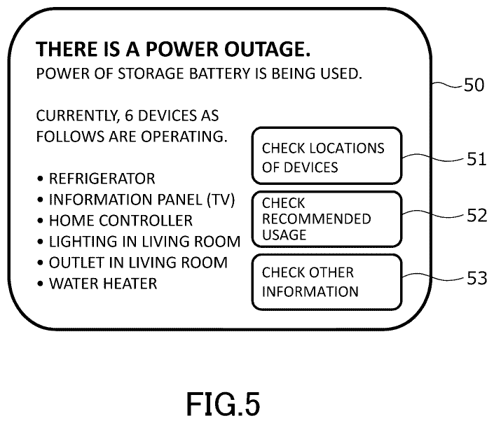

FIG. 5 is a diagram showing an example of information display on a terminal 50 of the home controller 22. The terminal 50 displays that there is a power outage, displays that power of the storage battery 16 is being used, and displays devices that can be operated with the storage battery 16. Information on the operable devices is information acquired from the device information database 46 (FIG. 3B). By looking at the terminal 50, the user can grasp the devices that can be used even during the power outage. The terminal 50 is, for example, a touch panel. The terminal 50 further displays a button 51 for checking the locations of the operable devices, a button 52 for checking a recommended usage (i.e., usage plan), and a button 53 for checking other information.

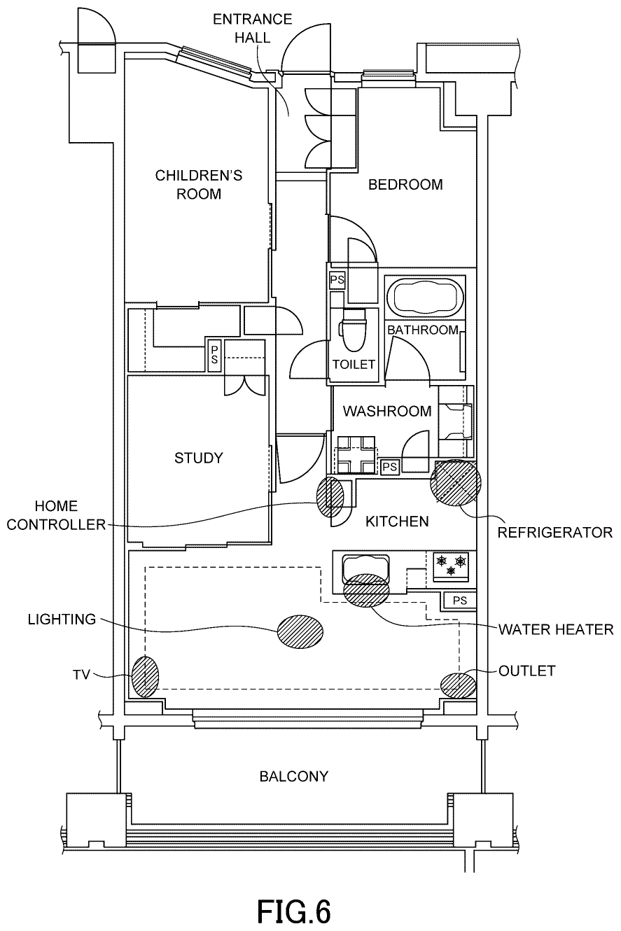

When the button 51 is tapped, the screen switches to a screen shown in FIG. 6. FIG. 6 is another diagram showing an example of information display on the terminal 50 of the home controller 22. The locations, in the facility (house), of the respective devices operable with the storage battery 16 are displayed with characters, graphics, symbols, colors, or a combination thereof. In the example shown in FIG. 6, on the floor plan of the facility, the location of each operable device is displayed with a combination of symbols (slanted lines) and characters. In such a display mode, even when there are many operable devices, the user can grasp the operable devices and the locations thereof at a glance.

When the button 53 is tapped, the other information necessary during a power outage is displayed. The other information may be disaster prevention information from a local government, based on the zip code for the address of the facility, or content provided by the administrator of the server 300. The disaster prevention information is, for example, evacuation area information.

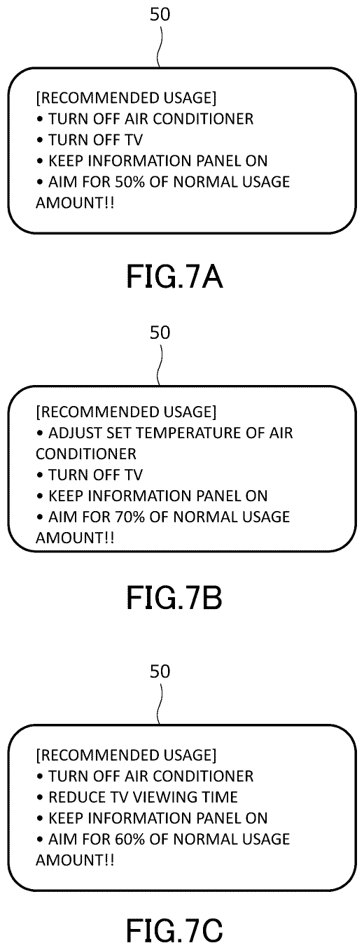

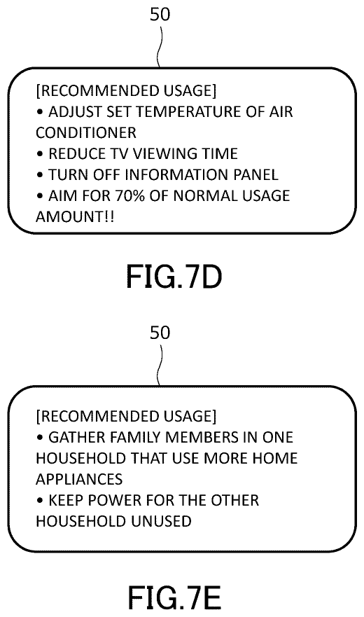

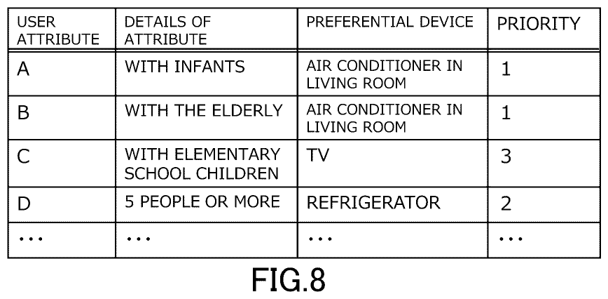

When the button 52 is tapped, the screen is switched to any of the screens shown in FIGS. 7A to 7E. FIGS. 7A to 7E are still other diagrams showing examples of information display on the terminal 50 of the home controller 22. Specifically, FIGS. 7A to 7E show examples of display of usage plans determined by the server 300.

FIG. 7A shows a usage plan displayed for the user having the user attribute E shown in FIG. 3A. Recommended usage is to turn off the air conditioner, turn off the TV, keep the information panel on, and aim for 50% of the normal usage amount. The user having the user attribute E is a user who can physically overexert himself/herself. Therefore, it is recommended to turn off the air conditioner and the TV which consume a great amount of power, so that the available time of the storage battery 16 is extended.

FIG. 7B shows a usage plan displayed for the user having the user attribute A shown in FIG. 3A. Recommended usage is to adjust the set temperature of the air conditioner, turn off the TV, keep the information panel on, and aim for 70% of the normal usage amount. The user having the user attribute A is a user having an infant as a family member. Since controlling the indoor temperature is important for infants, it is recommended to appropriately control the indoor temperature by using the air conditioner.

FIG. 7C shows a usage plan displayed for the user having the user attribute C shown in FIG. 3A. Recommended usage is to turn off the air conditioner, reduce the TV viewing time, keep the information panel on, and aim for 60% of the normal usage amount. The user having the user attribute C is a user having an elementary school child as a family member. Elementary school children have sufficient physical strength, but are not mentally patient in many cases. Therefore, it is recommended to use the TV that belongs to the category of “entertainment”.

FIG. 7D shows a usage plan displayed for the user having the user attribute B shown in FIG. 3A. Recommended usage is to adjust the set temperature of the air conditioner, reduce the TV viewing time, turn off the information panel, and aim for 70% of the normal usage amount. The user having the user attribute B is a user having the elderly as a family member. Since controlling the indoor temperature is important for the elderly, it is recommended to appropriately control the indoor temperature by using the air conditioner.

FIG. 7E shows a usage plan displayed for the user having a user attribute regarding a two-household house. Recommended usage is to gather family members of two households in one household that uses more devices than the other household, and keep power for the other household unused. When the storage battery 16 is installed in each of the two households, if family members gather in one household, the storage battery 16 for the other household can be kept unused. When the power of the storage battery 16 for one household has been used up, the family members can move to the other household and use the storage battery 16 for the other household.

As described with reference to FIGS. 7A to 7E, in the present embodiment, a device that is recommended to be preferentially used is determined according to the user attribute. The usage plan proposed to the user includes information on the device that is recommended to be preferentially used. For example, for the user having an infant or the elderly as a family member, controlling the indoor temperature by using the air conditioner is given priority over acquiring information from the information panel, and watching TV. For the user having neither infant nor elderly as a family member, acquiring information from the information panel is given priority over controlling the indoor temperature by using the air conditioner, and watching TV. For the user having an elementary school child as a family member, watching TV is given priority over controlling the indoor temperature by using the air conditioner. Thus, according to the method of the present embodiment, it is possible to provide the usage plan close to the users, taking into consideration the ages, number, health conditions, etc., of the users.

The example shown in FIG. 7A is an example in which the user attribute information does not include information indicating that the user includes at least one person selected from the group consisting of the elderly, infants, people having diseases, and pregnant women. In this case, the usage plan is determined to recommend reducing the target level of power consumption by the devices 28, 30, and 32 to a first level (50% of normal power consumption). Meanwhile, the examples shown in FIG. 7B and FIG. 7D are examples in which the user attribute information includes information indicating that the user includes at least one person selected from the group consisting of the elderly, infants, people having diseases, and pregnant women. In this case, the usage plan is determined so as to recommend reducing the target level of power consumption by the devices 28, 30, and 32 to a second level (60% or 70% of normal power consumption). The first level (50% of normal power consumption) is a lower target level of power consumption than the second level (60% or 70% of normal power consumption). In addition, the first level is a target level that encourages reduction in the pace of power consumption by the devices 28, 30, and 32, compared to the second level. If a usage plan is determined according to such rules, it is possible to propose a usage plan for the devices 28, 30, and 32 that is more suitable for the user who is concerned about his/her physical strength.

In the present embodiment, the usage plan includes not only information on a device that is recommended to be preferentially used, but also information on a device, the use of which is recommended to be avoided or reduced. Such information given to the user allows the user to use the device more appropriately, resulting in more appropriate power management.

As shown in FIGS. 7A to 7D, according to the method of the present embodiment, a message such as “Aim for . . . % of normal usage amount!” is displayed on the terminal 50. Here, the “normal usage amount” is power consumption of the devices 28, 30, and 32 in the normal time, recorded in the usage history information database 47 (FIG. 3D). The power consumption of the devices 28, 30, and 32 in the normal time may be the power consumption of yesterday, the power consumption of a specific day in the past such as the same date one year ago, or an average value of power consumption over a predetermined period such as the past one week. The “normal time” means when the devices 28, 30, and 32 are used with the commercial power supply. For example, it is assumed that the remaining power of the storage battery 16 at occurrence of a power outage is 5 kWh, and the total power consumption of the devices 28, 30, and 32 in the normal time for one day, which is recorded in the usage history information database 47, is 10 kWh. In this case, if the devices 28, 30, and 32 are used by the normal usage, the devices 28, 30, and 32 can be used for only half a day. For example, if the usage time is reduced to 50% of that in the normal time, the devices 28, 30, and 32 can be used for one day with the storage battery 16. As a usage plan for making the storage battery 16 usable for one day, a message such as “Aim for 50% of normal usage amount!!” is created and delivered to the user.

According to the present embodiment, the usage plan is determined such that the target level of power consumption of a specific device exceeds the target level of power consumption of a general device. Thus, it is possible to recommend the user to allocate power to an important device for the user. The specific device is a device that is recommended to be preferentially used. The general device is any device other than the specific device.

The “target level of power consumption” can be an index that is expressed by a ratio to the total power consumption of the devices 28, 30, and 32 for one day, which is specified based on the usage history.

The server 300 predicts (calculates) the available time of the devices 28, 30, and 32 with the storage battery 16 from the power consumption of the devices 28, 30, and 32 during the normal time, and the remaining power of the storage battery 16. Therefore, in addition to the message shown in FIG. 7A, the remaining power of the storage battery 16 and the predicated available time may be included in the usage plan. For example, a message “The present remaining power is 5 KW. The battery will run out in 5 hours” indicating the fact and the predicated available time, may be displayed on the terminal 50. This prevents the user from being confused by sudden running out of the battery, and allows the user to prepare for running out of the battery.

The message “Aim for 50% of normal usage amount!” recommends a pace of usage of the devices 28, 30, and 32, compared with the normal usage pace. That is, the usage plan includes an advice to make the devices 28, 30, and 32 available for a longer time than the predicted available time. The user reduces the power consumption by the devices 28, 30, and 32, according to the advice. In this case, it is possible to lower the risk that the battery runs out in a shorter time than the predicted available time.

FIG. 8 is a conceptual diagram of a priority rule to be referred to when a usage plan is determined. In the priority rule shown in FIG. 8, a device to be preferentially used is determined for each user attribute. For example, the device corresponding to the user attribute A is “air conditioner in the living room”. The device corresponding to the user attribute B is also “air conditioner in the living room”. The device corresponding to the user attribute C is “TV”. The device corresponding to the user attribute D is “refrigerator”. The device to be preferentially used can be specified based on the user attribute, with reference to the priority rule.

In the present embodiment, a usage plan for the devices 28, 30, and 32 is determined with reference to the user information associated with the facility, and the priority rule. As described above with reference to FIG. 3A, the user having the user ID of “No. 1” has the user attributes A and D. The air conditioner in the living room and the refrigerator, which are associated with the user attributes A and D in the priority rule and indicate high priority levels, are determined as devices that are recommended to be preferentially used. A usage plan for devices during a power outage is determined by using power consumption and priority levels of the devices. For example, the usage plan is determined such that the air conditioner in the living room and the refrigerator are used with power consumption being 70% of the normal usage mode, and the other devices are used with power consumption being 50% of the normal usage mode. The power consumption in the normal usage mode may be the power consumption recorded in the usage history information database 47.

For example, as a method for using the air conditioner in the living room while reducing the power consumption to 70% of the normal power consumption, a specific method such as raising the set temperature of air-conditioning by 1 degree may be displayed. In addition, the present usage status with respect to the target power consumption (70% of normal power consumption) may be displayed according to the settings of the device.

In the example shown in FIG. 8, the preferential devices are recorded in association with the user attributes. The preferential devices may be represented by the categories of the devices. For example, “air conditioner in the living room” is represented by the category of “air conditioning”. “TV” is represented by the category of “entertainment”. “Refrigerator” is represented by the category of “cooking”. In the priority rule, the device categories may be associated with the user attributes. In this case, as for all the devices that belong to the same category, preferential use or avoidance of use may be proposed.

A plurality of usage plans may be proposed as usage methods for the devices 28, 30, and 32. Proposing a plurality of usage plans allows various demands of the user to be met. The usage plans may include a usage plan with relatively short battery life, and a usage plan with relatively long battery life.

As shown in FIG. 3A, the user attribute information is recorded in association with the facility. For example, the user attribute information of the user who uses the facility is registered in advance through a smart speaker, a display, or the like. Thus, the user attribute information associated with the facility can be acquired. However, the user attribute information may not necessarily be directly associated with the facility. For example, a user may be firstly identified based on sensing information obtained from a detection device such as an image sensor installed in the facility, and user attribute information may be acquired for the user.

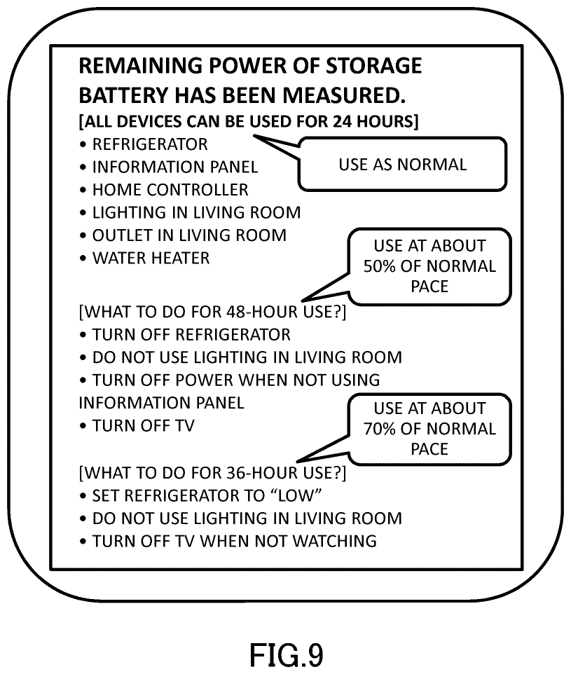

FIG. 9 shows an example of information display when a plurality of usage plans are proposed as methods for using the devices 28, 30, and 32. In the example shown in FIG. 9, three usage plans, i.e., “at normal pace”, “at about 50% of normal pace”, and “at about 70% of normal pace”, are proposed. The usage plan of “at normal pace” is a plan assuming that the storage battery 16 is used for 1 day (24 hours). A message “all devices can be used 24 hours” is displayed on the terminal 50. This usage plan has a relatively short available time, but is convenient and secure. This usage plan is useful for the user if it is expected that the commercial power supply 18 will be recovered soon. For example, a power outage caused by a lightning strike and a power outage caused by birds/animals contacting the electric equipment take a short time to recover the commercial power supply 18.

As shown in FIG. 9, each usage plan includes time information indicating a remaining available time when the devices 28, 30, and 32 are used with the storage battery 16. The available time is calculated from the usage history information of the devices 28, 30, and 32, and the remaining power information of the storage battery 16. The available time is formation that is a basis for realizing appropriate power management.

The usage plan of “at about 50% of normal pace” is a plan assuming that the storage battery 16 is used for 2 days (48 hours). This usage plan allows the storage battery 16 to be used for a long time, but is an inconvenient plan. This usage plan is useful for the user if it is expected that the commercial power supply 18 will not be recovered soon. For example, a power outage caused by a natural disaster such as typhoon and earthquake tends to take a long time to recover the commercial power supply 18. The usage plan of “at about 70% of normal pace” is a plan assuming that the storage battery 16 is used for 1.5 days (36 hours). This usage plan is a compromise between the two usage plans described above.

The usage plan of “at about 50% of normal pace” and the usage plan of “at about 70% of normal pace” indicate specific actions for reducing power consumption. The usage plan of “at about 50% of normal pace” provides an advice including “turn off the refrigerator”, “do not use the lighting in the living room”, “turn off the power when not using the information panel”, and “turn off the TV”. The advice includes information on the method for using the devices 28, 30, and 32. The usage plan of “at about 70% of normal pace” provides an advice including “set the refrigerator to low”, “do not use the lighting in the living room”, and “turn off the TV when not watching”. That is, the usage plan includes information on devices, the use of which is recommended to be avoided or reduced. For example, if the present season is winter and the outdoor temperature is sufficiently low, food can be preserved without using the refrigerator. Alternatively, the refrigerator may be almost empty. In such a case, the advice such as “turn off the refrigerator” is useful in the sense of making the user aware.

The usage plan of “at about 50% of normal pace” and the usage plan of “at about 70% of normal pace” each include information on a method for using the devices 28, 30, and 32 such that the actual usage time is extended to be longer than the available time (e.g., 24 hours) calculated based on the usage history information and the remaining power information. Such information is particularly useful for the user who desires to use the storage battery 16 for as long time as possible.

The available time is an available time regarding the devices 28, 30, and 32 that can be operated with the storage battery 16 during a power outage. Devices, such as the general load 26, which cannot be operated during a power outage are excluded from targets for which available time is calculated. Only the usage history information of the devices 28, 30, and 32 that can be operated with the storage battery 16 is acquired and used for calculation of the available time.

The numerical values of “50%” and “70%” in the plurality of usage plans shown in FIG. 9 may be appropriately changed. For example, an electric power company or an administration such as a local government may announce an estimated time required until recovery of the commercial power supply 18. The estimated time required until recovery may be acquired from the website of the electric power company or the local government to be used for determining the usage plan, in addition to the remaining power information and the usage history information. In this case, the usage plan for the devices 28, 30, and 32 can be determined such that the available time of the devices 28, 30, and 32 by the storage battery 16 becomes equal to or longer than the estimated time required until recovery of the commercial power supply 18. For example, if the estimated time required until recovery of the commercial power supply 18 is 5 hours, the usage plan is determined such that the available time of the devices 28, 30, and 32 by the storage battery 16 becomes 5 hours or more.

The estimated time required until recovery is not limited to that for the commercial power supply 18, and may be an estimated time required until recovery of city gas. This is because, for example, if a fuel cell is installed in the facility as a backup power supply, power can be generated according to supply of city gas.

In the method according to the present embodiment, devices that are recommended to be preferentially used are determined according to the user attribute. For example, the user having an attribute specified by the user attribute A is recommended to use the air conditioner. The device that is recommended to be preferentially used may be changed according to the season. This is because the need for the air conditioner is low in spring and autumn, and increases in summer and winter, especially in summer.

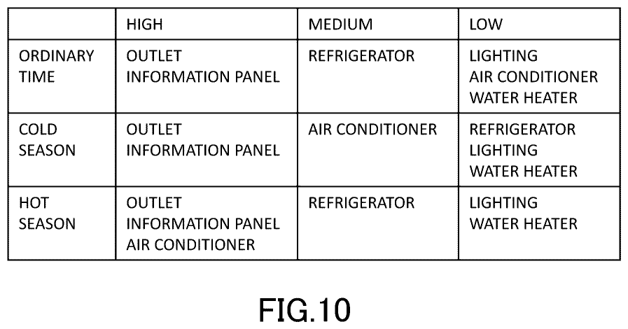

FIG. 10 is a conceptual diagram of a table that is used to change, according to the season, devices recommended to be preferentially used. This table is referred to when, for example, a usage plan is determined for the user having an attribute specified by the user attribute A (with infants). In the example shown in FIG. 10, “ordinary time” represents the spring season and the autumn season (March, April, May, September, October, November), “cold season” represents the winter season (December, January, February), and “hot season” represents the summer season (June, July, August). “High”, “medium”, and “low” represent priority levels. During the ordinary time, “outlet” and “information panel” are set to the priority level of “high”, “refrigerator” is set to the priority level of “medium”, and “lighting”, “air conditioner”, and “water heater” are set to the priority level of “low”. Thus, the user is recommended to preferentially use “outlet” and “information panel” during the ordinary time. In the cold season, “outlet” and “information panel” are set to the priority level of “high”, “air conditioner” is set to the priority level of “medium”, and “refrigerator”, “lighting”, and “water heater” are set to the priority level of “low”. Thus, the user is recommended to preferentially use “outlet” and “information panel” during the cold season. In the hot season, “outlet”, “information panel”, and “air conditioner” are set to the priority level of “high”, “refrigerator” is set to the priority level of “medium”, and “lighting” and “water heater” are set to the priority level of “low”. Thus, the user is recommended to preferentially use “outlet”, “information panel”, and “air conditioner” during the hot season.

The “ordinary time”, “cold season”, and “hot season” may be determined according to the outdoor temperature. That is, the device that is recommended to be preferentially used may be changed according to the outdoor temperature.

The user attribute may include information other than attributes unique to a person. For example, the user attribute may include an attribute of the facility. If the facility is a high floor of a condominium building, information indicating that the facility is the high floor of the condominium building is included in the user attribute. Elevators often stop when a power outage has occurred. In this case, it is difficult for residents of high floors to frequently go out using emergency stairs. If going out is restricted, the user may place importance on using the toilet. Therefore, when the information indicating that the facility is the high floor of the condominium building is included in the user attribute, for example, the toilet is set as a device that is recommended to be preferentially used. Thus, the user attribute may include information unique to the facility.

### Modification 1

As shown in FIG. 3A, a specific user may have a plurality of user attributes A and D. According to the priority rule shown in FIG. 8, a preferential device corresponding to the user attribute A is different from a preferential device corresponding to the user attribute D. The preferential device corresponding to the user attribute A is “air conditioner in the living room”. The preferential device corresponding to the user attribute D is “refrigerator”. That is, in the facility of the user having the user attributes A and D, there are a plurality of devices that are recommended to be preferentially used. In this case, information on the devices that are recommended to be preferentially used may be acquired from the priority rule table. As a result, in the facility of the user having the user attributes A and D, “air conditioner (air conditioning) in the living room” and “refrigerator (cooking)” are recommended to be preferentially used.

As shown in FIG. 8, a priority may be set for each preferential device. For example, the priority of “air conditioner (air conditioning) in the living room” is higher than the priority of “refrigerator (cooking)”, and the priority of “refrigerator (cooking)” is higher than the priority of “TV (entertainment)”. In this case, only information of the device associated with the highest priority may be acquired from the priority rule table.

For example, a device that is recommended to be preferentially used is defined as a specific device, and devices other than the specific device are defined as general devices. As shown in the priority rule in FIG. 8, the priority of the specific device is determined according to a plurality of user attributes different from each other. The priority represents a priority among a plurality of specific devices. When the user has a first user attribute (e.g., user attribute A) and a second user attribute (e.g., user attribute D) which are different from each other, and the priority of a first specific device (e.g., air conditioner in the living room) which is a specific device associated with the first user attribute is higher than the priority of a second specific device (e.g., refrigerator) which is a specific device associated with the second user attribute, a usage plan is determined such that the target level of power consumption of the first specific device exceeds the target level of power consumption of the second specific device. According to such a method, more appropriate usage plan can be delivered to the user. Even if there are a plurality of devices that are recommended to be preferentially used, setting the priorities as described above prevents the user from using all the devices at the same pace.

As described above, in the priority rule table, the user attribute, the preferential device, and the priority may be associated with each other. For example, the priority of the user attribute A is the highest, and the priority of the user attribute D is second highest. Therefore, a usage plan is determined such that “air conditioner in the living room” is used with power consumption at a ratio of 70% with respect to the normal usage mode, and “refrigerator” is used with power consumption at a ratio of 60% with respect to the normal usage mode. That is, a priority may be further determined among the items for which the priority levels are raised.

### Modification 2

As shown in FIG. 3A, the user having the user ID of No. 2 is associated with the user attribute C. In the user attribute C, the item having the highest priority level is the TV (entertainment). However, in the usage history information database shown in FIG. 3D, the usage history of the user having the user ID of No. 2 indicates that the amount of power used for the entertainment including the TV during the normal time is as low as 0.5 kWh. Therefore, it is assumed that the priority level of the TV is actually not high for the user having the user ID of No. 2. Thus, when the power consumption, in the normal time, of the item having the high priority level is lower than a predetermined reference, a usage plan may be created such that the priority level of the TV is not raised and is set at the same priority level as that of the other devices.

That is, a device that is recommended to be preferentially used is defined as a specific device, and devices other than the specific device are defined as general devices. In this case, if power consumption of the specific device during a predetermined period in the past is lower than a threshold power consumption, a usage plan is determined such that the target level of power consumption of the specific device is equal to the target level of power consumption of the general devices. For example, for the user having the user ID of No. 2, a usage plan in which power is used at a ratio of 50% with respect to the normal usage mode for all the items, is proposed. According to such a method, a more appropriate usage plan can be delivered to the user.

### Others

In step S6 of the flowchart shown in FIG. 4, the ratio of the target usage amount to the normal usage amount (e.g., 50%) may be calculated by using the remaining power of the storage battery 16 and information on restoration of infrastructure in the area where the facility is located. For example, if the commercial power supply 18 is expected to be restored in three days, the ratio of the target usage amount to the normal usage amount may be determined so that the user can pass three days with the storage battery 16. The “ratio of the target usage amount” may be a factor by which the normal usage amount is multiplied. If the ratio of the target usage amount is 50%, the factor is 0.5.

If the external environment is severe, the ratio of the target usage amount to the normal usage amount may be determined such that the power of the storage battery 16 can be used for a longer period of time than the expected days required for recovery. Examples of the severe external environment include the outdoor temperature (e.g., minimum temperature) equal to or lower than a predetermined temperature, and a weather forecast of heavy rain or typhoon.

When the user has a user attribute (user attribute A, B, etc.) indicated that a person whose ability to live independently is low is included, priority may be placed on improving the indoor environment, compared to the user who does not have such a user attribute. That is, the ratio of the target usage amount to the normal usage amount may be increased even if the available time of the storage battery 16 is reduced. Alternatively, the ratio of the target usage amount to the normal usage amount may be set so as to increase a difference between the above ratio of the device having the high priority level and the above ratio of the other devices.

In the server 300 shown in FIG. 2, the processor 41 serves as: a device information acquisition unit that acquires device information during a power outage; a user information acquisition unit that acquires user information; a remaining power information acquisition unit that acquires remaining power information of the storage battery 16; a plan determination unit that determines a usage plan; and an output unit that outputs the usage plan.

### INDUSTRIAL APPLICABILITY

The technique of the present disclosure is useful for facilities equipped with backup power supplies such as storage batteries, and is particularly useful for general households.

What is claimed is:

1. An information provision method for providing information on usage of devices in a facility during a power outage, the method comprising,
upon receiving power outage information indicating that a power outage has occurred in the facility,
acquiring remaining power information of a backup power supply installed in the facility, and device information on at least one device that is operable with the backup power supply,
acquiring user information of the device,
determining a usage plan for the device operable with the backup power supply, based on the remaining power information of the backup power supply and the user information, and
outputting the usage plan.

2. The information provision method according to claim 1 further comprising:
further acquiring usage history information of the device; and
determining the usage plan, based on the usage history information, the remaining power information, and the user information.

3. The information provision method according to claim 1, wherein
the user information includes user attribute information indicating a user attribute that is determined based on at least one selected from the group consisting of ages of people living or working in the facility, number of the people, sexes of the people, presence or absence of diseases, and presence or absence of pregnant women, and
the usage plan is determined according to the user attribute.

4. The information provision method according to claim 3, wherein
the device that is recommended to be preferentially used is determined according to the user attribute, and
the usage plan includes information on the device that is recommended to be preferentially used.

5. The information provision method according to claim 4, wherein
when the device that is recommended to be preferentially used is defined as a specific device, and the device other than the specific device is defined as a general device,
the usage plan is determined such that a target level of power consumption of the specific device exceeds a target level of power consumption of the general device.

6. The information provision method according to claim 5, wherein
a priority of the specific device is determined according to each of a plurality of user attributes different from each other,
the priority represents a priority among a plurality of specific devices, and
when a user has a first user attribute and a second user attribute that are the user attributes different from each other, and the priority of a first specific device that is the specific device associated with the first user attribute is higher than the priority of a second specific device that is the specific device associated with the second user attribute, the usage plan is determined such that the target level of power consumption of the first specific device exceeds the target level of power consumption of the second specific device.

7. The information provision method according to claim 4, wherein
when the device that is recommended to be preferentially used is defined as a specific device, and the device other than the specific device is defined as a general device,
the usage plan is determined such that, if power consumption of the specific device during a predetermined period in the past is lower than threshold power consumption, the target level of power consumption of the specific device is equal to the target level of power consumption of the general device.

8. The information provision method according to claim 3, wherein
when the user attribute information does not include information indicating that at least one person selected from the group consisting of the elderly, infants, people having diseases, and pregnant women is included in the user, the usage plan is determined so as to recommend reducing the target level of power consumption by the device to a first level,
when the user attribute information includes information indicating that at least one person selected from the group consisting of the elderly, infants, people having diseases, and pregnant women is included in the user, the usage plan is determined so as to recommend reducing the target level of power consumption by the device to a second level, and
the first level is a target level of power consumption lower than the second level.

9. The information provision method according to claim 5, wherein
the target level of power consumption is an index that is expressed by a ratio to power consumption for one day of the device, which is specified based on usage history of the device.

10. The information provision method according to claim 1, wherein
the facility is a general house, and
the user attribute is a family composition that is determined based on at least one selected from the group consisting of ages, number of people, sexes, presence or absence of diseases, and presence or absence of pregnant women.

11. The information provision method according to claim 2, wherein
the usage plan is determined based on the usage history information, the remaining power information, and the user information.

12. The information provision method according to claim 11, wherein
the usage plan includes time information indicating a remaining available time when the device is used with the backup power supply, and
the available time is calculated from the usage history information and the remaining power information.

13. The information provision method according to claim 12, wherein
the usage plan includes information on a method for using the device such that an actual usage time is extended to be longer than the available time calculated from the usage history information and the remaining power information.

14. The information provision method according to claim 3, wherein
the user attribute information is acquired from a database in which information on the user is recorded in advance.

15. The information provision method according to claim 1, wherein
the at least one device includes a plurality of devices, and
locations, in the facility, of the plurality of devices that are operable with the backup power supply are displayed and outputted with characters, graphics, symbols, colors, or a combination thereof.

16. The information provision method according to claim 1, wherein
the user information is recorded in advance on a database of a server on the web, and is acquired from the database,
the remaining power information is transmitted to the server via an energy management system installed in the facility together with the backup power supply, and
the usage plan is determined in the server.

17. An information provision system that provides information on usage of devices in a facility during a power outage, the system comprising:
a remaining power information acquisition unit that acquires remaining power information of a backup power supply installed in the facility, upon acquiring power outage information indicating that a power outage has occurred in the facility;
a device information acquisition unit that acquires, during the power outage, device information on at least one device that is operable with the backup power supply;
a user information acquisition unit that acquires user information of the device;
a plan determination unit that determines a usage plan for the device operable with the backup power supply, based on the remaining power information of the backup power supply and the user information; and
an output unit that outputs the usage plan.

18. A computer program for providing information on usage of devices in a facility during a power outage, the computer program causing a computer to execute,
upon receiving power outage information indicating that a power outage has occurred in the facility,
a process of acquiring remaining power information of a backup power supply installed in the facility, and device information on at least one device that is operable with the backup power supply,
a process of acquiring user information of the device,
a process of determining a usage plan for the device operable with the backup power supply, based on the remaining power information of the backup power supply and the user information, and
a process of outputting the usage plan.
